(19) United States
(12) Patent Application Publication
(10) Pub. No.: US 2008/0138561 A1
(43) Pub. Date: Jun. 12, 2008

(54) Molded Piece, Method for Producing the Molded Piece, and Apparatus For Producing the Molded Piece

(75) Inventor: Takao Umezawa, Gunma (JP)

Correspondence Address: OLIFF & BERRIDGE, PLC, P.O. BOX 320850, ALEXANDRIA, VA, 22320-4850, US

(73) Assignee: OSHIMA ELECTRIC WORKS CO., LTD., Ota-shi (JP)

(21) Appl. No.: 11/885,470

(22) PCT Filed: Mar. 9, 2006
(86) PCT No.: PCT/JP2006/304576

§ 371 Date: Aug. 31, 2007

(30) Foreign Application Priority Data
Mar. 10, 2005 (JP) 2005-067741

(51) Int. Cl. B29C 45/16; B29C 45/26; B29D 11/00

(52) U.S. Cl. 428/61; 425/588; 425/556; 264/255; 264/1.7; 428/68

(57) ABSTRACT

When a lamp unit is formed by applying a resinous material onto an abutting part between a lamp main body and a lens part through a secondary injection process, a mold receiving portion that is shaped like a concave groove and that is entered by a mold face is formed inside an abutting portion of the lamp main body so as to receive an injection force generated when secondary injection is performed. When the lamp main body is pushed out with the abutting portion and is extracted alone, the groove of the mold receiving portion is prevented from being expanded and deformed by receiving a load generated when pushed out. A reinforcing rib with which the mold receiving portion is filled is formed at a location that corresponds to a part of the mold receiving portion pushed out by a push-out member.

This application is the U.S. National Stage of PCT/JP2006/304576, filed Mar. 9, 2006, which claims priority from JP2005-067741, filed Mar. 10, 2005, the entire disclosures of which are incorporated herein by reference hereto.

### BACKGROUND

The present invention relates to a molded piece, a method for producing the molded piece, and an apparatus for producing the molded piece.

Generally, a molded piece, such as a side turn lamp that is produced through an injection molding process and is an example of a vehicle lamp unit, is formed such that a main body of the lamp unit (hereinafter, referred to as a “lamp main body”) into which a bulb is incorporated and a lens part are butted against each other to unite their abutting surfaces together. Bonding with an adhesive or fusing with heat or with ultrasonic waves is generally known as an abutting-surface uniting technique. According to these techniques, a lamp main body and a lens part that have been produced through an injection molding process are butted against each other to be united together in a state in which these workpieces have been extracted from their respective molds. Therefore, disadvantageously, various factors, such as inferiority in workability and nonuniformity in heat contraction, are combined together, and the resulting bonded surface or fused surface is not finely finished.

Therefore, a proposal has been made so that a lamp main body and a lens part are first molded through a primary injection step, are then butted against each other, and, in this state, are united together by applying a resinous material onto the periphery of these workpieces through a secondary injection step, thus producing a lamp unit. As a result, since lamp units are produced in the series of molding steps, workability is improved, and the abutting surface of the lamp main body and the abutting surface of the lens part are united integrally with each other so as to have a finely finished surface, thus obtaining superior design properties.

In this case, attention is required such that the abutting portion does not deform while receiving an injection pressure when the resinous material is applied during the secondary injection step. Accordingly, a proposal has been made to form a concave groove (a mold receiving portion) inside the abutting portion of the lamp main body so that secondary injection can be performed while allowing a mold part to enter the concave groove and to receive an injection pressure generated when the secondary injection is performed, thus preventing the abutting portion from being deformed by the injection pressure (see Japanese Published Unexamined Patent Application No. 2002-113741, for example). In this case, an integrally molded article obtained by the secondary injection is extracted from the mold by use of a push-out member (e.g. an ejector pin) structured to push out both of the secondarily injected resinous material and the abutting portion so that the molded article can be smoothly extracted therefrom (see Japanese Published Unexamined Patent Application No. 2003-291187, for example).

### SUMMARY

When a lamp unit is produced in the above-mentioned way, there is a case in which a semi-finished molded piece, such as a lamp main body, is extracted alone from the mold without changing the semi-finished molded piece, in order to perform a trial injection operation or confirm an injection state. In this case, the semi-finished molded piece obtained by the primary injection is extracted by being pushed by the push-out member. At this time, the semi-finished molded piece receives a load that acts as an external load in a direction to expand the concave groove that is used to receive the mold and that is formed immediately inside the abutting portion. Therefore, disadvantageously, the concave groove is liable to be easily deformed, and there is a fear that the semi-finished molded piece extracted therefrom cannot be reused.

Additionally, there is a lamp unit having projections, which are used to attach a molded piece, outside an abutting portion. However, structurally, the projections jut from a concave groove in a cantilever manner, and hence a load acting on the projection acts on the concave groove as an external load. Therefore, there is a fear that this groove will lead to a deficiency in strength. The present invention thus solves the above problems and is able to achieve other advantages.

According to a first exemplary aspect of the present invention, an apparatus for producing a molded piece includes a first mold that has mold faces used to form a first semi-finished molded piece and a second semi-finished molded piece, and a second mold that has mold faces used to form the first semi-finished molded piece and the second semi-finished molded piece. The apparatus being structured such that the first mold is structured to be relatively movable in a direction proceeding to or receding from the second mold and in a direction along a mold surface, the molded piece being produced through a primary injection step of forming the first semi-finished molded piece and the second semi-finished molded piece and through a secondary injection step of forming the molded piece by uniting an abutting portion of the first semi-finished molded piece and an abutting portion of the second semi-finished molded piece together. The apparatus also being structured such that when the first semi-finished molded piece is provided with a mold receiving portion that is shaped like a concave groove adjacent to the abutting portion and that is entered by a mold face of the first mold by receiving an injection pressure generated at the secondary injection step, the mold face forming the mold receiving portion also forming a reinforcing rib that reinforces the abutting portion having a part corresponding to a location that receives an external load by filling the part with the reinforcing rib.

According to a second exemplary aspect of the present invention, a method for producing a molded piece includes a primary injection step of forming a first semi-finished molded piece and a second semi-finished molded piece by structuring a first mold so as to be relatively movable in a direction proceeding to or receding from a second mold and in a direction along a mold surface, and a secondary injection step of forming the molded piece by uniting an abutting portion of the first semi-finished molded piece and an abutting portion of the second semi-finished molded piece together. The first mold having mold faces used to form the first semi-finished molded piece and the second semi-finished molded piece, and the second mold having mold faces used to form the first semi-finished molded piece and the second semi-finished molded piece. When the first semi-finished molded piece is provided with a mold receiving portion that is shaped like a concave groove adjacent to the abutting portion and that is entered by the mold face of the first mold by receiving an injection pressure generated at the secondary injection step, the mold receiving portion is provided with a reinforcing rib that reinforces the abutting portion having a part corresponding to a location that receives an external load by filling the part with the reinforcing rib.

According to a third exemplary aspect of the present invention, a molded piece is formed through a primary injection step of forming a first semi-finished molded piece and a second semi-finished molded piece by structuring a first mold so as to be relatively movable in a direction proceeding to or receding from a second mold and in a direction along a mold surface and through a secondary injection step of forming the molded piece by uniting an abutting portion of the first semi-finished molded piece and an abutting portion of the second semi-finished molded piece together. The first mold having mold faces used to form the first semi-finished molded piece and the second semi-finished molded piece and the second mold having mold faces used to form the first semi-finished molded piece and the second semi-finished molded piece. When the first semi-finished molded piece is provided with a mold receiving portion that is shaped like a concave groove adjacent to the abutting portion and that is entered by the mold face of the first mold by receiving an injection pressure generated at the secondary injection step, the mold receiving portion is provided with a reinforcing rib that reinforces the abutting portion having a part corresponding to a location that receives an external load by filling the part with the reinforcing rib.

According to exemplary aspects of the present invention, the mold receiving portion having a part corresponding to a part of the abutting portion of the first semi-finished molded piece that receives an external load is filled and reinforced with a reinforcing rib. As a result, a deficiency in strength is not caused even if the abutting portion receives an external load.

According to exemplary aspects of the present invention, even if the abutting portion receives an external load by allowing the push-out member to push out a first semi-finished molded piece when the first semi-finished molded piece is extracted in order to, for example, perform a trial injection operation, this portion can be prevented from being deformed. Therefore, the first semi-finished molded piece extracted from the mold can be reused.

According to exemplary aspects of the present invention, the projection used to attach a molded piece serving as a member is reinforced, and hence a strength deficiency can be overcome.

### BRIEF DESCRIPTION OF THE DRAWINGS

Various exemplary aspects of the invention will be described with reference to the drawings, wherein:

FIG. 1 is a rear view of a lamp unit;

FIG. 2 is a cross-sectional view of the lamp unit;

FIG. 3 is a schematic view of molds;

FIG. 4A to FIG. 4C are schematic views showing a first-half production process for producing a film-provided molded piece;

FIG. 5A to FIG. 5C are schematic views showing a middle-stage production process for producing a film-provided molded piece;

FIG. 6A to FIG. 6C are schematic views showing a middle-stage production process for producing a film-provided molded piece;

FIG. 7 is a rear view of a lamp unit according to a second embodiment of the present invention; and

FIG. 8 is a cross-sectional view of the lamp unit according to the second embodiment of the present invention.

### DETAILED DESCRIPTION OF EMBODIMENT

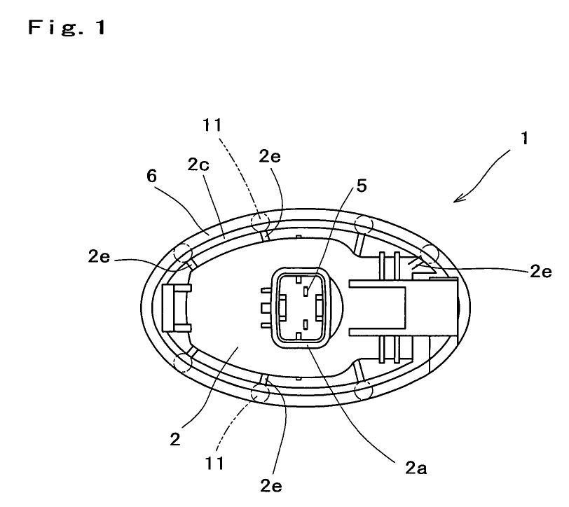

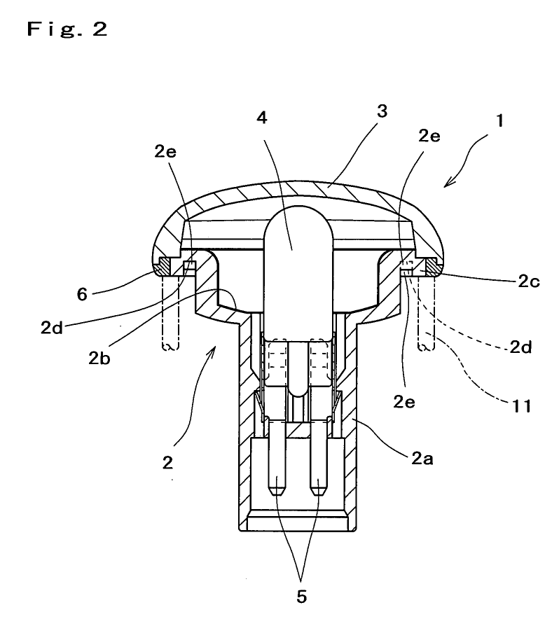

Embodiments of the present invention will be hereinafter described with reference to the accompanying drawings. In FIGS. 1 and 2, reference numeral 1 designates a lamp unit that is used for side turn signaling and that is an example of a film-provided molded piece. The lamp unit 1 is produced such that a lamp main body (first molded piece) 2 and a lens part (second molded piece) 3 both of which are molded through a primary injection step are united integrally with a resinous material 6 injected through a secondary injection step. The lamp main body 2 has a member incorporation portion 2a into which a bulb 4 and terminals 5, each of which is a built-in member, are incorporated. The lamp unit 1 is produced by undergoing a film forming step through which the lamp main body 2 is covered with a film 2b between the primary injection step and the secondary injection step.

The lamp main body 2 additionally has a mold receiving portion 2d shaped like a concave groove inside an abutting portion 2c that abuts on the lens part 3. In the mold receiving portion 2d, a part closely corresponding to a location pushed out by each of a plurality of push-out members 11 described later is filled with a reinforcing rib 2e. In this case, an amount in the mold receiving portion 2d to be filled with the reinforcing rib 2e depends on a desired strength, and can be set to reach a state in which the groove remains shallow, or a state in which the groove is exactly filled with the reinforcing rib 2e, or a state in which the groove is excessively filled therewith. If the groove is adjusted to have a shallow depth, molding is performed while a mold face enters this groove. As a result, advantageously, this groove part can be prevented from being deformed by injection pressure while undergoing a molding process at the secondary injection step, and the strength can be heightened.

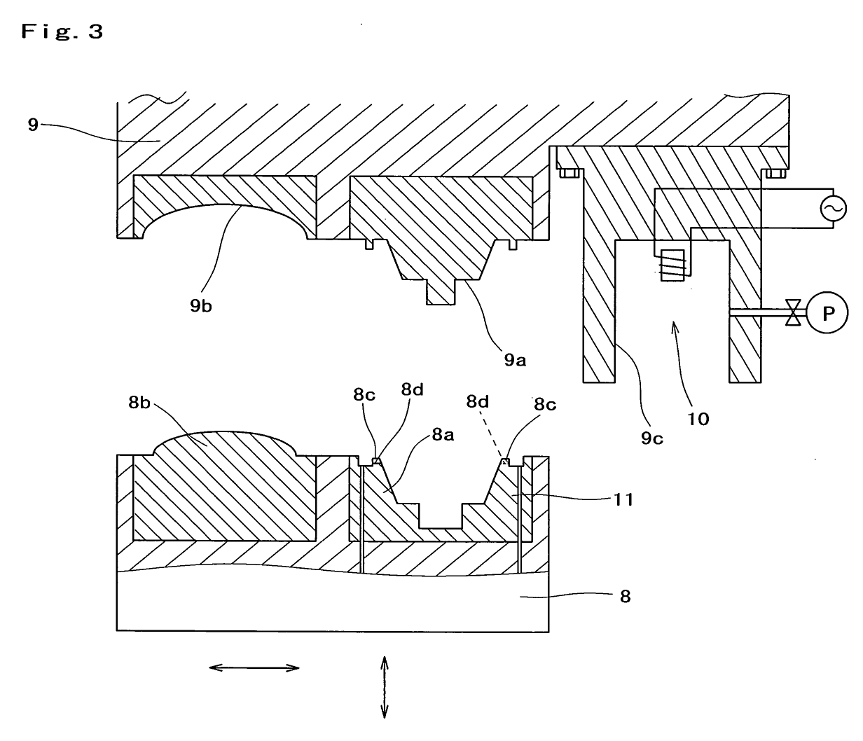

Next, a description will be given of an apparatus 7 for producing the lamp unit 1 as a film-provided molded piece (see FIG. 3). The apparatus 7 is made up of a movable mold 8 and a fixed mold 9. The movable mold 8 has mold faces 8a and 8b used to mold the lamp main body 2 and the lens part 3. The fixed mold 9 has mold faces 9a and 9b used to mold the lamp main body 2 and the lens part 3 and a film formation mold face 9c used to contain a film forming device 10. These mold faces can, of course, be structured such that a mold member and a film forming member each of which has a mold face corresponding to a mold base are detachably attached. The movable mold 8 additionally has the push-out members 11 used to extract the lamp unit 1 formed by secondary injection from the movable mold 8. The push-out members 11 are peripherally scattered in such a way as to bestride both the abutting portion 2c of the lamp main body 2 and the secondarily injected resinous material 6.

A mold face 8c for forming the mold receiving portion 2d is formed in convex shape on the mold face 8a of the movable mold 8 used to mold the lamp main body 2. A mold face 8d for forming the reinforcing rib 2e is formed by cutting a part of the mold face 8c close to the push-out member 11.

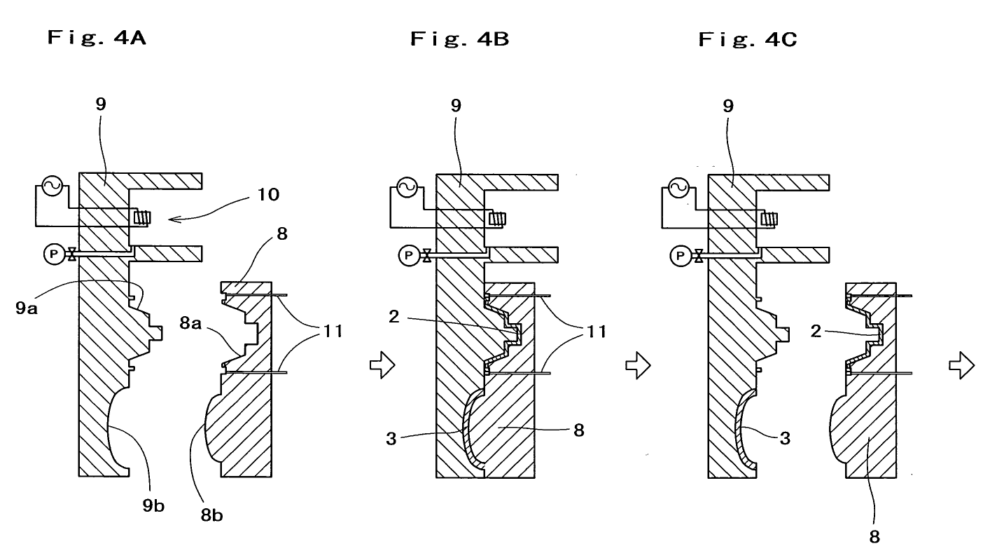

The movable mold 9 is structured so as to be movable in a direction in which the molds proceed to or recede from each other and be movable along the mold surface by an actuator (servomotor or cylinder), not shown. Next, a description will be given of a step of molding the lamp unit 1 while forming a film with reference to FIGS. 4A-6C. First, the movable mold 8 is moved and matched with the fixed mold 9 from a separated state (see FIGS. 4A and 4B) in which the mold faces 8a and 8b are positioned to face the mold faces 9a and 9b of the fixed mold 9, respectively. In the state of being matched with each other, a primary injection step is performed to mold the lamp main body 2 and the lens part 3 by injection molding (see FIG. 4B). Thereafter, the movable mold 8 is moved in the direction in which the molds recede from each other. The molds are designed so that, at this time, the lamp main body 2 remains on the side of the movable mold 8, whereas the lens part 3 remains on the side of the fixed mold 9 (see FIG. 4C).

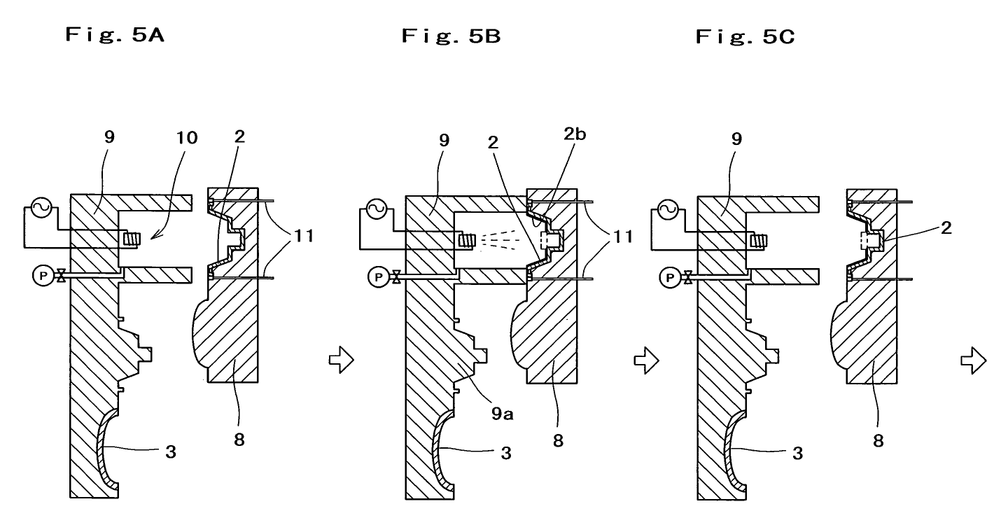

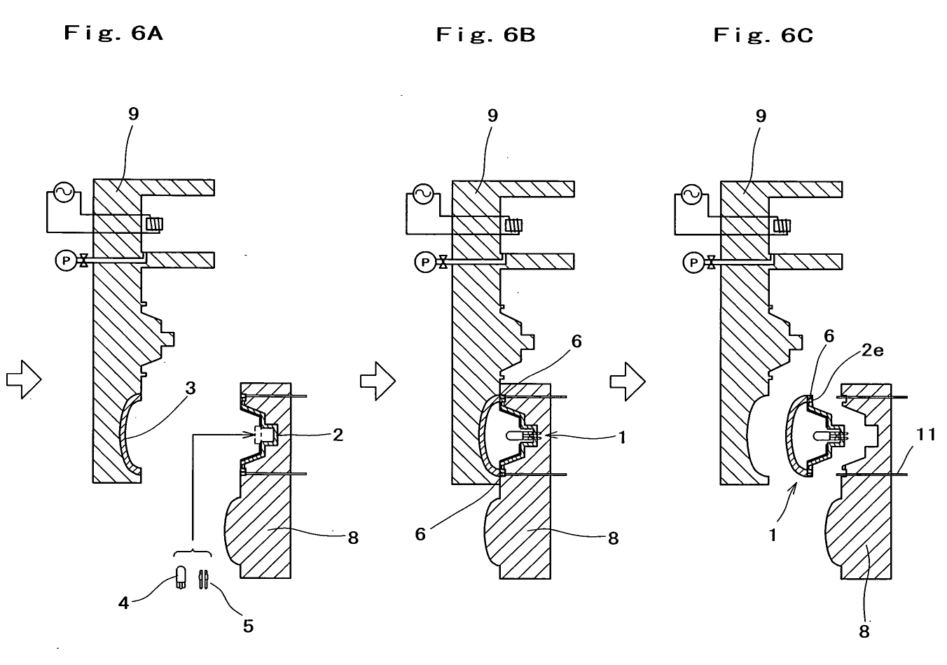

Thereafter, the movable mold 8 is moved in a direction along the mold surface (i.e., in the upward direction in the drawings) so that the lamp main body 2 faces the film forming device 10 (see FIG. 5A). The movable mold 8 is then moved in the mold matching direction. The lamp main body 2 matched with the film forming device 10 has its surface, which has receded from the mold face 9a, covered with a film 2b (see FIG. 5B). In the film forming step, the member incorporation portion 2a is masked with a masking material (not shown), and hence is not covered with the film 2b. Thereafter, the movable mold 8 is moved in the mold receding direction, and is separated from the film forming device 10 (see FIG. 5C). Thereafter, terminals 5 and a bulb 4 are incorporated into the member incorporation portion 2a, and the movable mold 8 is moved in the direction along the mold face 8c (i.e., in the downward direction in the drawings) so that the lamp main body 2 and the lens part 3 face each other (see FIG. 6A). In this state, the molds 8 and 9 are matched with each other, and a secondary injection step is performed to produce the lamp unit 1 by uniting the lamp main body 2 and the lens part 3 together with a resinous material 6 (see FIG. 6B). Thereafter, the movable mold 8 is moved in the mold receding direction, and the lamp unit 1 is extracted by the pushing operation of the push-out member 11 (see FIG. 6C). The movable mold 8 is again moved in the direction along the mold face (i.e., in the upward direction in the drawings) so that the mold faces 8a and 8b face the mold faces 9a and 9b, respectively. This series of steps is repeatedly performed, and the lamp unit 1 can be successively produced.

In the embodiment of the present invention structured as above, the lamp unit 1 is produced through the primary injection step through which the lamp main body 2 and the lens part 3 are molded, through the film forming step through which the lamp main body 2 is provided with a film, and through the secondary injection step through which the lamp main body 2 and the lens part 3 are united together. In this embodiment, the abutting portion 2c of the lamp main body 2 has the mold receiving portion 2d shaped like a concave groove thereinside, and molding is performed in a state in which the mold face 8c enters this portion. As a result, an injection pressure generated when secondary injection is performed is received thereby, and hence the abutting portion 2c is prevented from being deformed by receiving the injection pressure.

As described above, in the embodiment of the present invention, since the mold face entering the mold receiving portion 2d receives the injection pressure generated when secondary injection is performed, the abutting portion 2c is prevented from being deformed. If the lamp main body 2 is extracted alone in order to perform, for example, a trial injection operation, since the lamp main body 2 does not abut on the lens part 3, the abutting portion 2c is pushed out by the push-out member 11 under the state of low strength, and the lamp main body 2 is extracted. However, the reinforcing rib 2e is disposed at a location corresponding to a part to be pushed out of the mold receiving portion 2d, and hence the mold receiving portion 2d is prevented from being expanded and deformed, thus making it possible to extract the lamp main body 2 while maintaining its initial shape. Therefore, the lamp unit 1 can be produced by again setting the lamp main body 2 extracted therefrom in the movable mold 8.

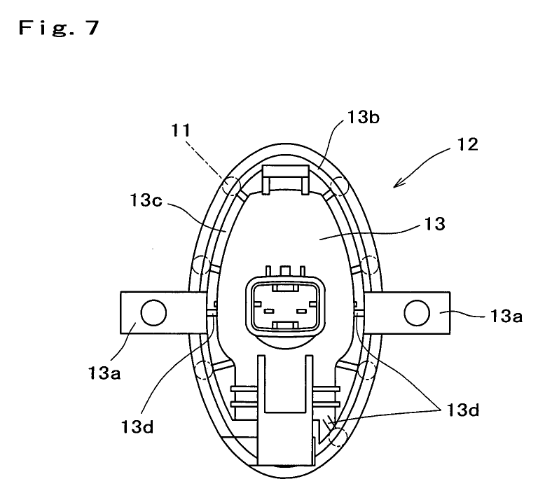

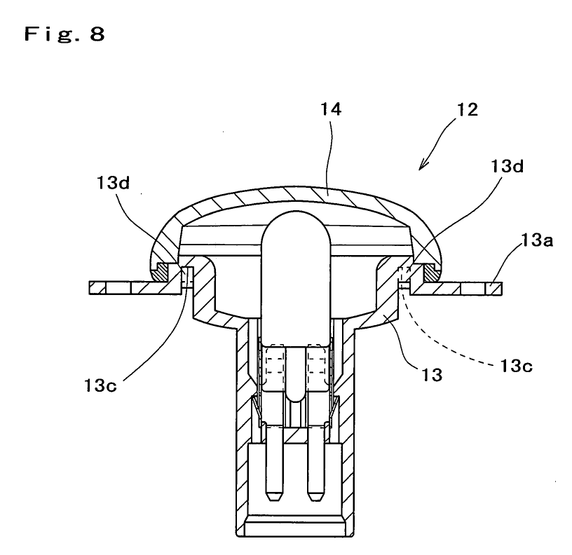

The present invention is not limited to the above embodiment, of course, and can employ a second embodiment shown in FIG. 7 and FIG. 8. In the second embodiment, a lamp unit 12 is made up of a lamp main body 13 and a lens part 14. The lamp main body 13 has projections 13a that are used to attach the lamp unit 12 to a vehicle body and that jut from an abutting portion 13b. The projection 13a easily receives an external load, for example, when attached by use of a screw. Therefore, a part of a mold matching portion 13c corresponding to the projection 13a is filled with a reinforcing rib 13d for reinforcement in the same way as the part to be pushed out by the push-out member 11. Therefore, the projection 13a can be reinforced.

The present invention is not limited to the above embodiments, of course. A film-provided molded piece formed by carrying out the present invention ranges dimensionally from a small-sized one, such as a vehicle side turn lamp, to a large-sized one, such as a back lamp or a front lamp. Examples of such film-provided molded pieces include an emblem, a colored lens, a number plate frame, an anticorrosion coated article, a cosmetic case, a grill, a magnetic or electromagnetic shielding product, a mirror, a garnish, an optical lens, a vehicle inner mirror, a molding, an abrasion-resistant article, a hubcap, an indoor illuminator (including a chandelier), a reflector, and a doorknob.

The present invention is useful as a molded piece used for a vehicle lamp unit or an emblem, as a method for producing the molded piece, and as an apparatus for producing the molded piece. The present invention is suitable to reuse a product extracted from a mold by preventing a mold-receiving concave groove from being deformed, and is suitable to prevent the concave groove from leading to a deficiency in strength.

1. An apparatus for producing a molded piece, the apparatus comprising:
a first mold that has mold faces used to form a first semi-finished molded piece and a second semi-finished molded piece; and
a second mold that has mold faces used to form the first semi-finished molded piece and the second semi-finished molded piece wherein:
the first mold being structured to be relatively movable in a direction proceeding to or receding from the second mold and in a direction along a mold surface;
the apparatus being structured such that the molded piece is produced through a primary injection step of forming the first semi-finished molded piece and the second semi-finished molded piece and through a secondary injection step of forming the molded piece by uniting an abutting portion of the first semi-finished molded piece and an abutting portion of the second semi-finished molded piece together;
the apparatus also being structured such that when the first semi-finished molded piece is provided with a mold receiving portion that is shaped like a concave groove adjacent to the abutting portion and that is entered by a mold face of the first mold by receiving an injection pressure generated at the secondary injection step, the mold face forming the mold receiving portion also forming a reinforcing rib that reinforces the abutting portion having a part corresponding to a location that receives an external load by filling the part with the reinforcing rib.

2. The apparatus for producing the molded piece according to claim 1, wherein the part of the abutting portion that receives the external load is a part corresponding to a push-out member that pushes out the molded piece produced as a result of unification by secondary injection.

3. The apparatus for producing the molded piece according to claim 1, wherein the part of the abutting portion that receives the external load is a part corresponding to an attachment piece that is used to attach the molded piece as a member and that juts out of the abutting portion.

4. A method for producing a molded piece, the method comprising:
forming a first semi-finished molded piece and a second semi-finished molded piece using a first mold that is relatively movable in a direction proceeding to or receding from a second mold and in a direction along a mold surface; and
forming the molded piece by uniting an abutting portion of the first semi-finished molded piece and an abutting portion of the second semi-finished molded piece together, wherein
the first mold having mold faces used to form the first semi-finished molded piece and the second semi-finished molded piece;
the second mold having mold faces used to form the first semi-finished molded piece and the second semi-finished molded piece; and
when the first semi-finished molded piece is provided with a mold receiving portion that is shaped like a concave groove adjacent to the abutting portion and that is entered by a mold face of the first mold by receiving an injection pressure generated when the first semi-finished molded piece and the second semi-finished molded piece are united, the mold receiving portion is provided with a reinforcing rib that reinforces the abutting portion having a part corresponding to a location that receives an external load by filling the part with the reinforcing rib.

5. The method for producing the molded piece according to claim 4, wherein the part of the abutting portion that receives the external load is a part corresponding to a push-out member that pushes out the molded piece produced as a result of unification of the first semi-finished molded piece and the second semi-finished molded piece.

6. The method for producing the molded piece according to claim 4, wherein the part of the abutting portion that receives the external load is a part corresponding to an attachment piece that is used to attach the molded piece as a member and that juts out of the abutting portion.

7. A molded piece formed through a primary injection step of forming a first semi-finished molded piece and a second semi-finished molded piece by structuring a first mold so as to be relatively movable in a direction proceeding to or receding from a second mold and in a direction along a mold surface and through a secondary injection step of forming the molded piece by uniting an abutting portion of the first semi-finished molded piece and an abutting portion of the second semi-finished molded piece together, wherein:
the first mold having mold faces used to form the first semi-finished molded piece and the second semi-finished molded piece,
the second mold having mold faces used to form the first semi-finished molded piece and the second semi-finished molded piece;
when the first semi-finished molded piece is provided with a mold receiving portion that is shaped like a concave groove adjacent to the abutting portion and that is entered by a mold face of the first mold by receiving an injection pressure generated at the secondary injection step, the mold receiving portion is provided with a reinforcing rib that reinforces the abutting portion having a part corresponding to a location that receives an external load by filling the part with the reinforcing rib.

8. The molded piece according to claim 7, wherein the part of the abutting portion that receives the external load is a part corresponding to a push-out member that pushes out the molded piece produced as a result of unification by secondary injection.

9. The molded piece according to claim 7, wherein the part of the abutting portion that receives the external load is a part corresponding to an attachment piece that is used to attach the molded piece as a member and that juts out of the abutting portion.

10. The apparatus for producing the molded piece according to claim 1, wherein the first semi-finished molded piece is a lamp main body and the second semi-finished molded piece is a lens part.

11. The method for producing the molded piece according to claim 4, wherein the first semi-finished molded piece is a lamp main body and the second semi-finished molded piece is a lens part.

12. The molded piece according to claim 7, wherein the first semi-finished molded piece is a lamp main body and the second semi-finished molded piece is a lens part.

13. The apparatus for producing the molded piece according to claim 1, wherein the second mold includes a film forming device that forms a film on the first semi-finished molded piece.

14. The method for producing the molded piece according to claim 4, wherein the first semi-finished molded piece is covered with a film after the first semi-finished molded piece and the second semi-finished molded piece are formed but before uniting the first semi-finished molded piece and the second semi-finished molded piece.

15. The molded piece according to claim 7, wherein the first semi-finished molded piece is covered with a film.
